(19) United States
(12) Patent Application Publication
(10) Pub. No.: US 2020/0046126 A1
(43) Pub. Date: Feb. 13, 2020

(54) PASSENGER SEAT HAVING AN EXPANDABLE BACK REST

(71) Applicant: Airbus Operations GmbH, Hamburg (DE)

(72) Inventor: Nicolas TSCHECHNE, Hamburg (DE)

(21) Appl. No.: 16/534,372

(22) Filed: Aug. 7, 2019

(30) Foreign Application Priority Data
Aug. 10, 2018 (DE) 10 2018 119 502.8

(51) Int. Cl. A47C 7/46; B64D 11/06

(52) U.S. Cl. CPC A47C 7/46; B60N 2/242; B64D 11/0639

(57) ABSTRACT

A passenger seat comprises a seat element and a back rest. The back rest comprises a main body and at least one expansion portion which is adjustable between a first operating position and a second operating position. In its first operating position, the expansion portion is integrated in the main body of the back rest. By contrast, in its second operating position, the expansion portion defines a supporting element extending from a back rest surface of the main body.

### CROSS-REFERENCES TO RELATED APPLICATIONS

This application claims the benefit of the German patent application No. 10 2018 119 502.8 filed on Aug. 10, 2018, the entire disclosures of which are incorporated herein by way of reference.

### FIELD OF THE INVENTION

The invention relates to a passenger seat which is suitable for use in a passenger cabin of an aircraft, but also for use in other means of transport, such as, for example, buses or trains. Furthermore, the invention relates to an aircraft equipped with a passenger seat of this type.

### BACKGROUND OF THE INVENTION

Modern passenger aircraft are conventionally equipped with passenger seats which have a back rest which is adjustable between an upright position and a reclined position. However, at least the back rests of seats installed in the Economy Class area of an aircraft passenger cabin conventionally cannot be folded back to such an extent that passengers sitting on the seats can take up a comfortable lying position. However, not least because of increasingly longer flight distances and consequently longer flight times, it is of importance for many passengers to rest and sleep during the flight.

At the same time, the optimum use of the space available in a passenger cabin is of great economic importance. Therefore, in particular in the Economy Class of the aircraft passenger cabin, seat rows arranged one behind another and next to one another are positioned at the smallest possible distances from one another.

### SUMMARY OF THE INVENTION

The invention is based on an object of providing a space-saving passenger seat which provides increased comfort, in particular, for a resting or sleeping passenger. Furthermore, the invention is based on an object of specifying an aircraft equipped with a passenger seat of this type.

A passenger seat comprises a seat element and a back rest. The back rest is preferably pivotable relative to the seat element between an upright position, in which a back rest surface of the back rest extends substantially perpendicularly to a seat surface of the seat element, and a reclined position, in which the back rest surface of the back rest forms an angle greater than 90° with the seat surface of the seat element. The term “seat surface” refers here to a seat element surface which faces the back rest and on which a user of the passenger seat can sit in the customary manner. The term “back rest surface” refers here to a front surface of the back rest, against which a user of the passenger seat can lean in the customary manner when the user is sitting on the seat surface of the seat element.

The back rest comprises a main body and at least one expansion portion. The main body of the back rest can have a substantially cuboidal basic shape and, depending on requirements, can be provided with rounded or beveled edges or corners. A head rest which is formed separately from the main body can be adjacent to an end of the main body that faces away from the seat element. However, it is also conceivable to equip the passenger seat with a head rest formed in a manner integrated with the main body of the back rest.

Furthermore, the back rest of the passenger seat comprises an expansion portion which is adjustable between a first operating position and a second operating position. In its first operating position, the expansion portion is integrated in the main body of the back rest. If, by contrast, the expansion portion is in its second operating position, it defines a supporting element extending from the back rest surface of the main body.

The back rest of the passenger seat therefore undergoes a change in volume during an adjustment of the expansion portion between its first operating position and its second operating position. As long as the expansion portion is in its first operating position, it does not take up any separate volume, but rather is integrated at least substantially completely in the volume of the main body. Only in its second operating position, that is to say, when it defines the supporting element, does the expansion portion increase the overall volume of the back rest.

When the expansion portion is in its first operating position, the volume and the appearance of the passenger seat consequently do not differ from the volume and the appearance of a conventional passenger seat having a back rest of, for example, substantially cuboidal design. The passenger seat then requires a minimum amount of space. Furthermore, operations, such as, for example, entry or exit operations into/out of an aircraft passenger cabin equipped with the passenger seat, or the cleaning of the aircraft passenger cabin are not impaired or obstructed by the expansion portion of the passenger seat.

By contrast, in its second operating position, the expansion portion increases the use comfort of the passenger seat. In particular, a user of the passenger seat is provided with an additional supporting or holding functionality by means of the supporting element which is defined by the expansion portion in its second operating position. For example, the user can use the supporting element, which extends from the back rest surface of the main body, as a back support when the user is in a lateral position. The possibilities are thereby extended for the user to change his/her sitting position, which affords a considerable gain in comfort, in particular on long flights. Furthermore, lateral resting or sleeping positions become significantly more comfortable.

The expansion portion is preferably arranged in the region of a side edge of the back rest, said side edge extending in the direction of a longitudinal axis of the back rest. The supporting element which is defined by the expansion portion in its second operating position then ensures optimum lateral support without significantly reducing the back rest surface of the back rest.

The supporting element which is defined by the expansion portion in its second operating position can form an angle of approx. 60 to 120°, preferably an angle of approx. 70 to 110°and, particularly preferably, an angle of approx. 80 to 100° with the back rest surface of the main body. However, a transition region between the main body and the supporting element is preferably formed in a rounded manner in order not to impair the comfort for the user of the passenger seat.

In principle, it is conceivable that the supporting element, which is defined by the expansion portion in its second operating position, extends over the entire length of the back rest, as viewed along the longitudinal axis of the back rest. Alternatively thereto, it is, however, also conceivable that the supporting element, which is defined by the expansion portion in its second operating position, extends over merely part of the length of the back rest, as viewed along the longitudinal axis of the back rest. For example, the passenger seat can be equipped with an expansion portion which is arranged in the region of a back rest end facing away from the seat element. However, the supporting element, which is defined by the expansion portion in its second operating position, preferably extends from a region of the back rest surface of the main body, said region being adjacent to the seat element. The supporting element is then particularly readily suitable for supporting the back region of a user resting or sleeping in a lateral position on the passenger seat.

The expansion portion preferably comprises a supporting structure which is adjustable between a collapsed position and an expanded position. In its collapsed position, the supporting structure preferably permits the expansion portion to be integrated in the main body of the back rest, whereas, in its expanded position, it is preferably capable of holding the expansion portion in its second operating position and of thereby defining the supporting element which extends from the back rest surface of the main body.

The supporting structure is preferably provided with a locking mechanism which is configured to lock the supporting structure in its expanded position and consequently to hold the supporting element in a dimensionally stable manner. The locking mechanism can be a mechanism which can be actuated separately. However, the locking mechanism is preferably in the form of an automatic mechanism which automatically ensures locking of the supporting structure in its expanded position as soon as the supporting structure has reached its expanded position. Furthermore, the locking mechanism is preferably configured to be deactivated manually. For example, the locking mechanism can be configured in such a manner that it is deactivated when a manual pressure directed towards the back rest surface of the main body is exerted on an edge of the supporting element, said edge facing away from the back rest surface of the main body.

The supporting structure of the expansion portion can have various design shapes. For example, the expansion portion can be provided with a foldable supporting structure frame. However, the supporting structure preferably comprises a plurality of half shells which are connected to one another by means of a connecting element. The half shells are preferably composed of a plastics material. The connecting element can be designed in the form of a cord. However, the connecting element is preferably in the form of a rubber element, in particular a rubber hinge.

In the collapsed position of the supporting structure, the half shells are preferably oriented in the same direction and stacked in one another. As a result, the supporting structure takes up particularly little space, and therefore the expansion portion can be readily integrated in the main body of the back rest. By contrast, in the expanded position of the supporting structure, preferably in each case two half shells are oriented in opposite directions and form a full shell shape. This permits the desired increase in volume of the expansion portion in a simple manner. The half shells can be formed hemispherically but also in the shape of a half egg or in some other way.

In the expanded position of the supporting structure, the two half shells which are oriented in opposite directions preferably intermesh in each case in the region of their mutually facing edges and thereby lock the supporting structure in its expanded position. In the case of a supporting structure comprising a plurality of half shells, the locking mechanism of the supporting structure is consequently preferably formed by the intermeshing edges of the half shells. A locking mechanism of this type is automatic, i.e., it does not require any separate activation and consequently any additional activity by the user. The expansion portion of the passenger seat can then be operated particularly simply and comfortably.

In a preferred embodiment of the passenger seat, the supporting element which is defined by the expansion portion in its second operating position is supported in the region of a rear side facing away from the back rest surface of the main body by means of an arm rest of the passenger seat. If the rear surface of the supporting element that faces away from the back rest surface of the main body lies against an arm rest of the passenger seat and the supporting element thereby experiences additional support, the supporting structure of the expansion portion is relieved of load and, as a result, may be of smaller dimensions and consequently lighter in weight.

The expansion portion preferably comprises a cover and/or a cushion. The cover assigned here to the expansion portion is preferably formed integrally with a cover extending over the main body of the back rest. In a similar manner, the cushion which is assigned here to the expansion portion can also be formed integrally with a cushion used for the upholstery for the main body. The cover assigned to the expansion portion and/or the cushion assigned to the expansion portion can take up a folded configuration when the expansion portion is in its first operating position. In contrast thereto, the cover assigned to the expansion portion and/or the cushion assigned to the expansion portion preferably takes/take up an unfolded configuration when the expansion portion is in its second operating position.

Alternatively or additionally, a support can be arranged on the back rest and/or the seat element. In particular, the support can be provided on the back rest surface and/or the seat surface and can serve for increased comfort of the user of the passenger seat. For example, the support is an upholstered support which is fastened on the back rest surface and/or the seat surface. The expansion portion moves together with the support when the expansion portion is adjusted between its first and second operating position. The manner of operation is therefore the same as in the case of a passenger seat without a support.

The passenger seat can be provided with an, for example, electrically actuable driving device for adjusting the expansion portion between its first operating position and its second operating position. However, the expansion portion is preferably adjustable manually between its first operating position and its second operating position. A passenger seat equipped with a manually adjustable expansion portion requires only a little, or no, additional outlay on maintenance. Furthermore, the weight of a driving device for the automatic adjustment of the expansion portion can be saved. For example, the expansion portion can be configured in such a manner that it is brought from its first operating position into its second operating position if a manual tensile force directed away from the back rest surface of the main body is exerted on the expansion portion. By contrast, in order to adjust the expansion portion from its second operating position into its first operating position, a manual pressure directed towards the back rest surface of the main body can be exerted on an edge of the supporting element that faces away from the back rest surface of the main body.

The expansion portion preferably comprises a handle which is configured to be gripped by a user in order to adjust the expansion portion between its first operating position and its second operating position. The handle can be fastened, for example, to the cover and/or to the cushion of the expansion portion. The handle is preferably recessed into the back rest surface of the main body so as not to impair the comfort for a user of the passenger seat.

In a preferred embodiment, the passenger seat comprises a first and a second expansion portion adjustable between a first operating position and a second operating position. By means of the provision of two expansion portions, the possibilities for a user of the passenger seat to change his/her sitting position are additionally extended, which results in a further gain in comfort.

The first and the second expansion portion are preferably arranged in the region of two opposite side edges of the back rest, said side edges extending in the direction of the longitudinal axis of the back rest. The two expansion portions can then ensure lateral support on both sides without significantly reducing the back rest surface of the back rest.

An aircraft comprises at least one above-described passenger seat. In particular, a passenger cabin of the aircraft is equipped with a plurality of above-described passenger seats in an Economy Class area and/or in a Premium Economy Class area.

### BRIEF DESCRIPTION OF THE DRAWINGS

A preferred embodiment of the invention will now be explained in more detail with reference to the attached schematic drawings, of which

FIG. 1 shows a three-dimensional view of a passenger seat suitable for use in a passenger cabin of an aircraft,

FIG. 2 shows a top view of the passenger seat according to FIG. 1,

FIG. 3 shows a front view of the passenger seat according to FIG. 1,

FIG. 4 shows a supporting structure installed in the passenger seat according to FIGS. 1 to 3 in a collapsed or an expanded position, and

FIG. 5 shows an aircraft equipped with a passenger seat according to FIGS. 1 to 3.

### DETAILED DESCRIPTION OF THE PREFERRED EMBODIMENTS

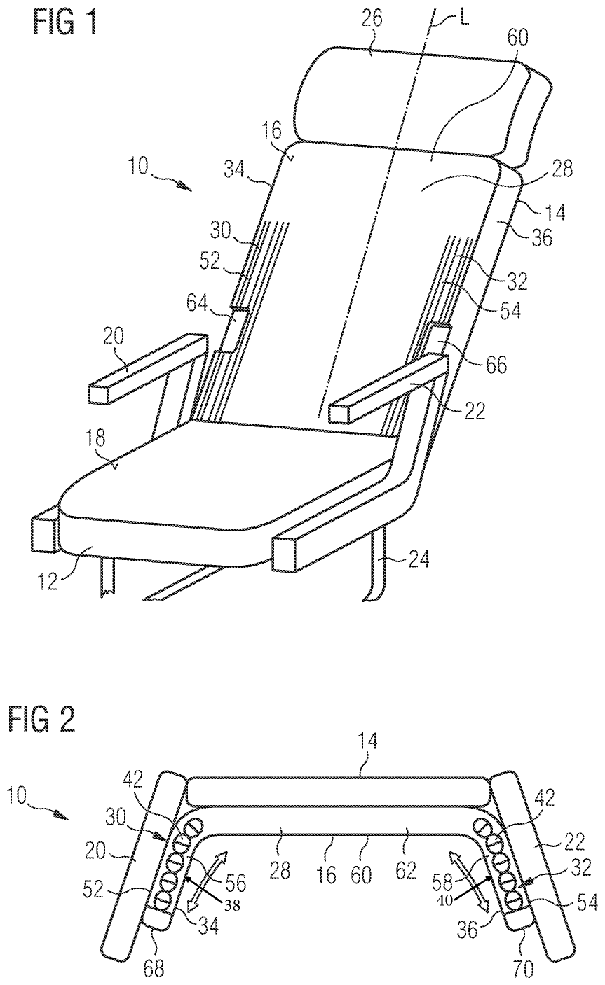

FIGS. 1 to 3 show various views of a passenger seat 10 which is suitable, for example, for use in a passenger cabin of an aircraft 100 shown in FIG. 5. In the case of the aircraft 100 illustrated in FIG. 5, the Economy Class area and/or a Premium Economy Class area of the passenger cabin is/are equipped with a plurality of passenger seats 10 arranged one behind another in a plurality of rows.

A passenger seat 10 comprises a seat element 12 and a back rest 14. The back rest 14 is pivotable relative to the seat element 12 between an upright position, in which a back rest surface 16 of the back rest 14 extends substantially perpendicularly to a seat surface 18 of the seat element 12, and a reclined position, in which the back rest surface 16 of the back rest 14 forms an angle greater than 90° with the seat surface 18 of the seat element 12.

Furthermore, the passenger seat 10 is provided with two arm rests 20, 22 which are each connected to a substructure 24 of the passenger seat 10 and extend substantially parallel to the seat surface 18 of the seat element 12 in a manner offset laterally relative to the seat element 12 and the back rest 14. Finally, the passenger seat 10 comprises a head rest 26 which, in the case of the passenger seat 10 illustrated in FIGS. 1 to 3 is designed in the form of a separate component and is connected to an end of the back rest 14, which end faces away from the seat element 12. However, it is also conceivable to equip the passenger seat 10 with a head rest 26 which is formed in a manner integrated with the back rest 14.

The back rest 14 comprises a main body 28 which, in the case of the passenger seat 10 shown in FIGS. 1 to 3, has a substantially cuboidal basic shape with rounded edges and corners. Furthermore, the back rest 14 is provided with at least one expansion portion. The exemplary embodiment of a passenger seat 10 that is illustrated in FIGS. 1 to 3 comprises a first expansion portion 30 and a second expansion portion 32. Each of the expansion portions 30, 32 is arranged in the region of a side edge 34, 36 extending in the direction of a longitudinal axis L of the back rest 14. In particular, the first expansion portion 30 is arranged in the region of a first side edge 34 (on the left in the figures) of the back rest 14 while the second expansion portion 32 is arranged in the region of a second side edge 36 which is opposite the first side edge 34 and is on the right in the figures.

Each of the expansion portions 30, 32 is adjustable between a first operating position and a second operating position. In the first operating position, each of the expansion portions 30, 32 is integrated in the main body 28 of the back rest 16. FIG. 1 shows the passenger seat 10 in a state in which the two expansion portions 30, 32 are in their first operating position and consequently do not take up a separate volume, but rather are substantially completely integrated in the volume of the main body 28 of the back rest 14. The volume and the appearance of the passenger seat 10 then do not differ from the volume and the appearance of a conventional passenger seat, and therefore, despite the presence of the expansion portions 30, 32, the passenger seat 10 does not need a greater amount of space than a conventional passenger seat without expansion portions 30, 32.

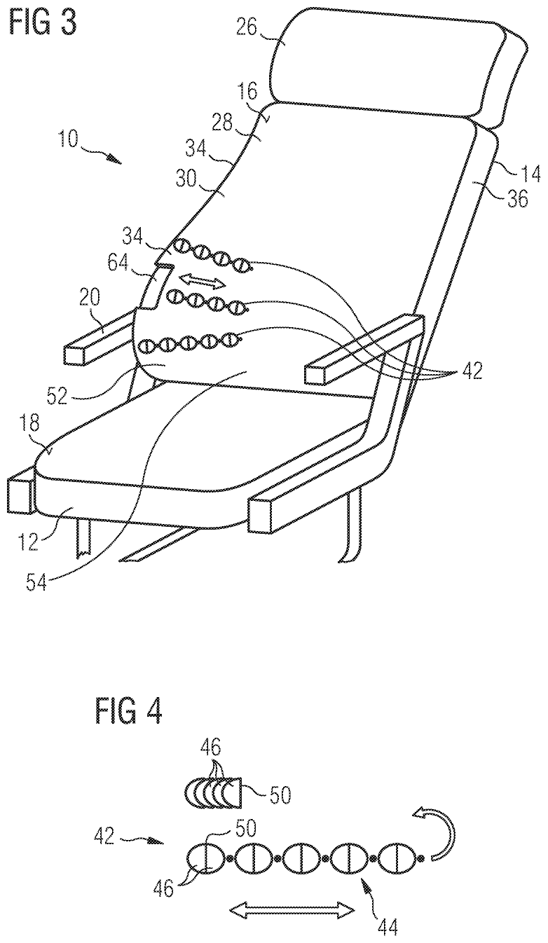

In contrast thereto, each of the expansion portions 30, 32 in its second operating position defines a supporting element 38, 40 extending from the back rest surface 16 of the back rest 14 or of the back rest main body 28. In the top view of the passenger seat 10 according to FIG. 2, the two expansion portions 30, 32 are shown in their second operating position. The first expansion portion 30 consequently defines a first supporting element 38 which extends from the back rest surface 16 of the back rest main body 28 along the first side edge 34 (on the left in the figures) of the back rest 14. By contrast, the second expansion portion 32 defines a second supporting element 40 which extends from the back rest surface 16 of the back rest main body 28 along the second side edge 36 (on the right in the figures) of the back rest 14. Only the first expansion portion 30 is shown in its second operating position in FIG. 3.

During adjustment of the expansion portions 30, 32 from their first operating position into their second operating position, the back rest 14 of the passenger seat 10 therefore undergoes an increase in volume and provides an additional supporting or holding functionality for a user of the passenger seat 10 by means of the supporting elements 38, 40, which are defined by the expansion portions 30, 32. The possibilities for the user to change and comfortably maintain his/her sitting position on the passenger seat 10 are thereby extended. Each of the supporting elements 38, 40 defined by the expansion portions 30, 32 in their second operating position forms an angle of approx. 80 to 100° and, in particular, essentially 90° with the back rest surface 16 of the main body 28 of the back rest 14, with a transition region between the main body 28 and the supporting elements 38, 40, however, being of rounded design in each case in order to increase the comfort.

In the case of the exemplary embodiment of a passenger seat 10 that is shown in FIGS. 1 to 3, the supporting elements 38, 40 which are defined by the expansion portions 30, 32 in their second operating position extend over only part of the length of the back rest 14, as viewed along the longitudinal axis L of the back rest 14. In particular, the two expansion portions 30, 32 are arranged in the region of an end of the back rest 14 that is adjacent to the seat element 12, and therefore the supporting elements 38, 40 which are defined by the expansion portions 30, 32 extend from a region of the back rest surface 16 of the back rest main body 28, which region is adjacent to the seat element 12. The supporting elements 38, 40 are then particularly readily suitable for supporting the back region of a user resting or sleeping in a lateral position on the passenger seat 10.

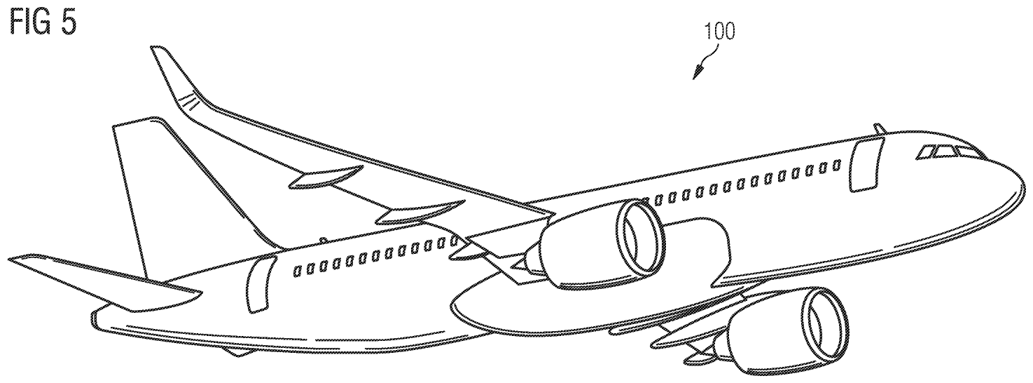

As can best be seen in FIGS. 2 and 3, each of the expansion portions 30, 32 comprises a supporting structure 42 which is adjustable between a collapsed position, shown at the top in FIG. 4, and an expanded position, shown at the bottom in FIG. 4. The supporting structure 42, in its collapsed position, permits the expansion portions 30, 32 to be integrated in the main body 28 of the back rest 14, whereas it is capable, in its expanded position, of holding the expansion portions 30, 32 in its second operating position and of thereby defining the supporting elements 38, 40 extending from the back rest surface 16 of the main body 28. The supporting structure 42 is provided with an automatic locking mechanism 44 which fixes the supporting structure 42 in its expanded position without a separate activation being required for this purpose.

The supporting structure 42 can have various design forms. However, the passenger seat 10 shown in the figures is equipped with a supporting structure 42 which comprises a plurality of substantially hemispherical half shells 46 manufactured from a plastic material. The half shells 46 are connected to one another in a series arrangement by means of a connecting element 48 designed in the form of a rubber element, in particular, a rubber hinge.

In the collapsed position (illustrated at the top in FIG. 4) of the supporting structure 42, all of the half shells 46 are oriented in the same direction and stacked in one another. In the arrangement shown at the top of FIG. 4, all of the open edges 50 of the half shells 46 point to the right. The supporting structure 42 then takes up a merely small volume, as a result of which easy integration of the expansion portions 30, 32 into the back rest main body 28 is made possible.

By contrast, in the expanded position (illustrated at the bottom in FIG. 4) of the supporting structure 42, in each case two half shells 46 are oriented in opposite directions and form a full shell shape. This permits the desired increase in volume of the expansion portions 30, 32 in a simple manner. In particular, the two half shells 46 which are oriented in opposite directions each intermesh in the region of their mutually facing edges 50 and thereby lock the supporting structure 42 automatically in its expanded position. In other words, in the case of the exemplary embodiment of a supporting structure 42 that is illustrated in the figures, the automatic locking mechanism is formed by the intermeshing edges of the half shells 46.

Each of the expansion portions 30, 32 comprises a cover 52, 54 and a cushion 56, 58. In the case of the exemplary embodiment of a passenger seat 10 that is shown in the figures, the covers 52, 54 of the expansion portions 30, 32 are in each case formed integrally with a cover 60 extending over the main body 28 of the back rest 14. In a similar manner, the cushions 56, 58 assigned to the expansion portions 30, 32 are also in each case formed integrally with a cushion 62 used for the upholstery of the main body 28. As can best be seen in FIG. 1, the covers 52, 54 and the cushions 56, 58 of the expansion portions 30, 32 each take up a folded configuration when the expansion portions 30, 32 are in their first operating position. By contrast thereto, the covers 52, 54 and the cushions 56, 58 of the expansion portions 30, 32 each take up an unfolded configuration when the expansion portions 30, 32 are in their second operating position, see FIGS. 2 and 3.

In principle, the passenger seat 10 can be provided with a, for example, electrically actuable driving device for adjusting the expansion portions 30, 32 between their first operating position and their second operating position. However, in the embodiment of a passenger seat 10 that is illustrated in the figures, the expansion portions 30, 32 are each adjustable manually between their first operating position and their second operating position. In order to facilitate the manual adjustment of the expansion portions 30, 32 by a user of the passenger seat 10, each of the expansion portions 30, 32 comprises a handle 64, 66 which is in each case configured to be grasped by a user in order to adjust the corresponding expansion portion 30, 32 between its first operating position and its second operating position. The handles 64, 66 which are composed here of a plastics material are each connected to the covers 52, 54 and the cushions 56, 58 of the expansion portions 30, 32 and are recessed into the back rest surface 16 of the back rest main body 28, and therefore no loss in comfort for a user of the passenger seat 10 arise because of the handles 64, 66.

Each of the expansion portions 30, 32 can be brought from its first operating position into its second operating position by a user grasping the corresponding handle 64, 66 and exerting a manual tensile force on the expansion portion 30, 32, said manual tensile force being directed away from the back rest surface 16 of the main body 28. As a result, the covers 52, 54 and the cushions 56, 58 of the expansion portions 30, 32 are unfolded and the supporting structure 42 transferred from its collapsed configuration into its expanded configuration. As soon as the half shells 46 of the supporting structure 42 have reached the arrangement which is illustrated at the bottom in FIG. 4 and in which in each case two half shells 46 are oriented in opposite directions and intermesh in the region of their mutually facing edges 50, the supporting structure 42 is automatically locked.

The supporting elements 38, 40 which are defined by the expansion portions 30, 32 in their respective second operating position are supported in the region of a rear side facing away from the back rest surface 16 of the main body 28 in each case by one of the arm rests 20, 22 of the passenger seat 10, i.e., the rear surface of each supporting element 38, 40, the rear surface facing away from the back rest surface 16 of the main body 28, lies against an arm rest 20, 22 of the passenger seat 10, and therefore the supporting element 38, 40 undergoes an additional support. The supporting elements 38, 40 which are defined by the expansion portions 30, 32 are thereby held securely in their position.

By contrast, in order to adjust the expansion portions 30, 32 from their second operating position into their first operating position, all that is needed is to exert a manual force, which is directed towards the back rest surface 16 of the main body 28, on an edge 68, 70, which faces away from the back rest surface 16 of the main body 28, of the supporting elements 38, 40 defined by the expansion portions 30, 32. The compressive force causes the supporting structure 42 to collapse and causes its collapsed configuration shown at the top in FIG. 4. At the same time, the covers 52, 54 and the cushions 56, 58 of the expansion portions 30, 32 are folded up, and therefore the expansion portions 30, 32, as desired, can be integrated again in the main body 28 of the back rest 14.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A passenger seat, comprising:
a seat element, and
a back rest,
wherein the back rest comprises a main body and at least one expansion portion adjustable between a first operating position and a second operating position, and
wherein the expansion portion, in the first operating position, is integrated in the main body of the back rest and, in the second operating position, defines a supporting element extending from a back rest surface of the main body.

2. The passenger seat according to claim 1, wherein the expansion portion is arranged in a region of a side edge of the back rest, said side edge extending in a direction of a longitudinal axis of the back rest.

3. The passenger seat according to claim 1, wherein the supporting element, which is defined by the expansion portion in the second operating position, forms an angle of approximately 60 to 120° with the back rest surface of the main body.

4. The passenger seat according to claim 1, wherein the supporting element, which is defined by the expansion portion in the second operating position, forms an angle of approximately 70 to 110° with the back rest surface of the main body.

5. The passenger seat according to claim 1, wherein the supporting element, which is defined by the expansion portion in the second operating position, forms an angle of approximately 80 to 100° with the back rest surface of the main body.

6. The passenger seat according to claim 1, wherein the supporting element, which is defined by the expansion portion in the second operating position, extends from a region of the back rest surface of the main body, said region being adjacent to the seat element.

7. The passenger seat according to claim 1, wherein the expansion portion comprises a supporting structure adjustable between a collapsed position, in which the supporting structure permits the expansion portion to be integrated in the main body of the back rest, and an expanded position, in which the supporting structure is capable of holding the expansion portion in the second operating position.

8. The passenger seat according to claim 7, wherein the supporting structure comprises a locking mechanism for locking the supporting structure in the expanded position.

9. The passenger seat according to claim 7,
wherein the supporting structure comprises a plurality of half shells which are connected to one another by means of a connecting element,
wherein, in the collapsed position of the supporting structure, the half shells are oriented in the same direction and stacked in one another, and
wherein, in the expanded position of the supporting structure, in each case, two half shells are oriented in opposite directions and form a full shell shape.

10. The passenger seat according to claim 9, wherein, in the expanded position of the supporting structure, the two half shells, which are oriented in opposite directions, each intermesh in a region of their mutually facing edges and thereby lock the supporting structure in its expanded position.

11. The passenger seat according to claim 1, wherein the supporting element, which is defined by the expansion portion in the second operating position, is supported in the region of a rear side facing away from the back rest surface of the main body by means of an arm rest of the passenger seat.

12. The passenger seat according to claim 1, wherein the expansion portion comprises at least one of a cover or a cushion, which cover or cushion takes up a folded configuration when the expansion portion is in the first operating position, and which cover or cushion takes up an unfolded configuration when the expansion portion is in the second operating position.

13. The passenger seat according to claim 1, wherein the expansion portion is adjustable manually between the first operating position and the second operating position.

14. The passenger seat according to claim 1, wherein the expansion portion comprises a handle configured to be grasped by a user in order to adjust the expansion portion between the first operating position and the second operating position.

15. The passenger seat according to claim 1, which comprises a first and a second expansion portion, each adjustable between the first operating position and the second operating position.

16. The passenger seat according to claim 15, wherein the first and the second expansion portion are arranged in a region of two opposite side edges of the back rest, said side edges extending in a direction of the longitudinal axis of the back rest.

17. An aircraft comprising at least one passenger seat according to claim 1.
